(19) United States
(12) Patent Application Publication
(10) Pub. No.: US 2014/0025639 A1
(43) Pub. Date: Jan. 23, 2014

(54) DATA BACKUP, STORAGE AND MANAGEMENT SYSTEM AND METHODOLOGY

(71) Applicants: Nathan Daniel Weinstein, Glastonbury, CT (US); Garold C. Miller, Glastonbury, CT (US)

(72) Inventors: Nathan Daniel Weinstein, Glastonbury, CT (US); Garold C. Miller, Glastonbury, CT (US)

(73) Assignee: HALO2CLOUD LLC, Glastonbury, CT (US)

(21) Appl. No.: 14/032,824

(22) Filed: Sep. 20, 2013

Related U.S. Application Data
(62) Division of application No. 13/352,036, filed on Jan. 17, 2012.

(51) Int. Cl. G06F 17/30

(52) U.S. Cl. CPC G06F 17/30289
USPC 707/654

(57) ABSTRACT

Systems and methods for simultaneously providing local data backup and online data backup. A local backup device is programmed with an application, which allows a user to connect a client device to the local backup device and to an online backup service so that data backup can be done simultaneously to the local backup device and to the online backup service.

### CROSS-REFERENCE TO RELATED APPLICATION

This is a divisional application claiming the benefit of U.S. Non-Provisional patent application Ser. No. 13/352,036, filed Jan. 17, 2012, and U.S. Provisional Application No. 61/433,418, filed Jan. 17, 2011, which is incorporated herein by reference.

### FIELD OF INVENTION

The present invention is generally directed to a data backup, storage and management system, and more particularly to an online system for consumers to backup and store their date both locally and offsite, while permitting easy management of such data regardless of where it is backed up and stored.

### BACKGROUND

Data in computer systems may need to be backed up for a variety of reasons, such as facilitating recovery of data lost during computer system failures. Certain backup systems may store and manage data locally and other backup systems may store and manage data remotely.

### SUMMARY

HALO2CLOUD is the first system to combine local onsite backup of computers, PDAs and tablets, cloud offsite backup, and cloud storage, with a simple to use, comprehensive HALO web portal to manage the cloud backup and cloud storage information. Accordingly, the present invention facilitates data backup, data storage, access and data management, and remote device control for consumers, with the security of a Fortune 500 company.

A sophisticated program (a.k.a., DS Client Installer Program) has been designed to automatically install the Halo2Cloud system (a.k.a., DS Client Software) on computers by simply connecting the Halo device (a.k.a., local backup device) and establishing a username and password. A personal cloud portal is then automatically created which provides the consumer with access to all of their data.

The HALO web portal allows a user to view or download cloud backup data or cloud storage. The web portal also allows a user to upload files to a cloud storage database. Files can be shared from either one's cloud backup or cloud storage database to online resources, including social networking sites such as FACEBOOK® and TWITTER®. A user can also create a unique My Halo Page and share files with friends and family by providing them with a username and password to connect to the unique My Halo Page.

To back up Personal Computers, MAC computers, Tablets, and Personal Device assistants (PDAs), a HALO application (a.k.a., DS Client Software) is automatically transferred to the user's primary device via an external USB™ storage device or wireless storage device (a.k.a., local backup device). The application (a.k.a., DS Client Software) then automatically creates schedules to backup information (files and settings) on a regular basis. The application (a.k.a., DS Client Software) creates two separate backups, one to the onsite local external USB™ device (a.k.a., local backup device) and the other to the HALO Cloud system (a.k.a., remote backup system). Typically, the backups are created simultaneously to eliminate the risk of data being lost or corrupted. In some embodiments, the backups of files do not overwrite previous backups of the same files. Accordingly, various copies and/or versions of a file may be backed up.

In the data storage aspect of the present invention, the user has the capability of management and organizing the data as it sees fit. Management of data on offsite cloud storage can be done from anywhere via the Internet, a virtual private network (VPN) or the like. Files on the Cloud storage system can be personalized as one see fits, as illustrated in the enclosed examples.

For PDAs and tablets, the present invention backs up emails, calendar items, contacts, configuration settings, installed applications, text messages, pictures, videos, alarm clock settings, browser settings, call logs, sound and display settings, and user dictionary. As more items become available from the PDA/tablets operating system vendors, those additional items will be added to the backup.

In addition to Personal Computers, MAC computers, Tablets, and PDAs, HALO2CLOUD will also install onto HALO embedded appliances such as refrigerators, thermostats, lighting devices, and cable boxes. All of the settings from these devices will be backed up both locally to the HALO device and to the HALO Cloud system.

The HALO web portal may also include a HALO Control Panel to enable HALO embedded appliances to be controlled, typically remotely via the Internet, a VPN or the like, by means of the HALO web portal. Examples of this include changing the temperature of a HALO embedded thermostat; turning off HALO embedded lights, and adding items to a shopping list on a HALO embedded refrigerator. These activities can be done global merely by accessing one's HALO Cloud through existing telecommunications devices.

### BRIEF DESCRIPTION OF THE FIGURES

The foregoing summary, as well as the following detailed description of the preferred embodiments, is better understood when read in conjunction with the appended drawings. The enclosed Figures illustrate features of the data backup, storage and management capabilities of the present invention. For the purpose of illustrating the invention, there is shown in the drawings embodiments that are presently preferred, it being understood, however, that the invention is not limited to the specific embodiments disclosed. In the drawings:

FIG. 1 is a diagram of a data backup, storage and management system in accordance with an illustrative embodiment of the invention;

FIG. 2 is a flowchart of a DS Client installation routine in accordance with an illustrative embodiment of the invention;

FIG. 3 shows a graphical user interface used in connection with the DS Client installation routine of FIG. 2;

FIG. 4 shows another graphical user interface used in connection with the DS Client installation routine of FIG. 2;

FIG. 5 shows another graphical user interface used in connection with the DS Client installation routine of FIG. 2;

FIG. 6 shows another graphical user interface used in connection with the DS Client installation routine of FIG. 2

FIG. 7 is a flowchart of a DS Mobile Client installation routine in accordance with an illustrative embodiment of the invention;

FIG. 8 shows an exemplary web browser interface associated a web portal of the present invention;

FIG. 9 shows another exemplary web browser interface associated a web portal of the present invention;

FIG. 10 shows another exemplary web browser interface associated a web portal of the present invention;

FIG. 11 shows another exemplary web browser interface associated a web portal of the present invention;

FIG. 12 shows another exemplary web browser interface associated a web portal of the present invention;

FIG. 13 shows another exemplary web browser interface associated a web portal of the present invention;

FIG. 14 shows another exemplary web browser interface associated a web portal of the present invention;

FIG. 15 shows another exemplary web browser interface associated a web portal of the present invention;

FIG. 16 shows another exemplary web browser interface associated a web portal of the present invention;

FIG. 17 shows another exemplary web browser interface associated a web portal of the present invention;

FIG. 18 shows another exemplary web browser interface associated a web portal of the present invention;

FIG. 19 shows another exemplary web browser interface associated a web portal of the present invention;

FIG. 20 shows another exemplary web browser interface associated a web portal of the present invention;

FIG. 21 shows another exemplary web browser interface associated a web portal of the present invention;

FIG. 22 shows another exemplary web browser interface associated a web portal of the present invention;

FIG. 23 shows another exemplary web browser interface associated a web portal of the present invention;

FIG. 24 shows another exemplary web browser interface associated a web portal of the present invention;

FIG. 25 shows another exemplary web browser interface associated a web portal of the present invention;

FIG. 26 shows another exemplary web browser interface associated a web portal of the present invention;

FIG. 27 shows another exemplary web browser interface associated a web portal of the present invention;

FIG. 28 shows another exemplary web browser interface associated a web portal of the present invention;

FIG. 29 shows another exemplary web browser interface associated a web portal of the present invention;

FIG. 30 shows another exemplary web browser interface associated a web portal of the present invention;

FIG. 31 shows another exemplary web browser interface associated a web portal of the present invention;

FIG. 32 shows another exemplary web browser interface associated a web portal of the present invention;

FIG. 33 shows another exemplary web browser interface associated a web portal of the present invention;

FIG. 34 shows another exemplary web browser interface associated a web portal of the present invention;

FIG. 35 shows another exemplary web browser interface associated a web portal of the present invention; and

FIG. 36 shows another exemplary web browser interface associated a web portal of the present invention.

### DETAILED DESCRIPTION

The description of embodiments and features of the present invention provide herein and in the enclosed materials has been presented for the purpose of illustration and description. It is not intended to be exhaustive or to limit the present invention to the form disclosed. Obvious modifications and variations are possible in light of this disclosure. The embodiments described and illustrated were chosen to best illustrate the principles of the present invention and practical applications thereof to enable one of ordinary skill in the art to utilize the invention in various embodiments and with various modifications as suited to the particular use contemplated.

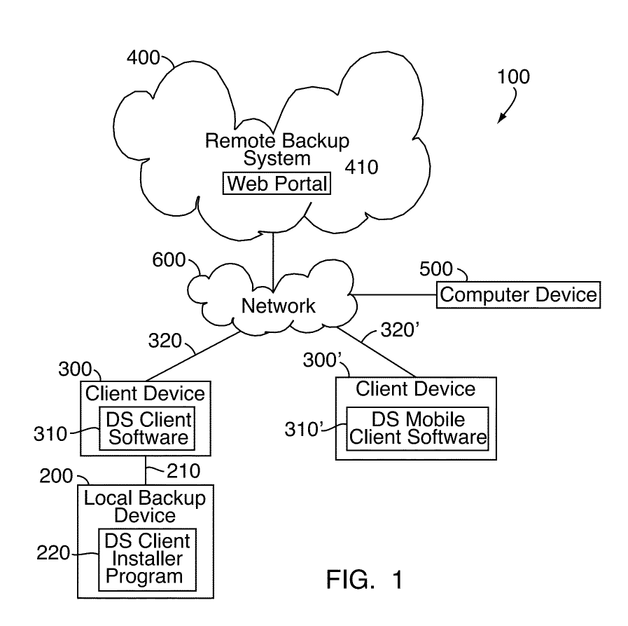

The present application is directed to systems and methods for local and remote data backup, storage and management. In an exemplary embodiment, as illustrated in FIG. 1, a data backup system 100 comprises a local backup device 200, a client device 300, a remote backup system 400, and a computer device 500. Local backup device 200 is preferably a backup disk that is adapted to connect to a client device 300. Client device 300 contains data that a client wishes to backup to local backup device 200 and/or remote backup system 400. Remote backup system 400 provides online backup services for client devices 300 via network 600. Online back services provided by remote backup system 400 may be accessed via a web portal 410 with a computer device 500 that is connected to remote backup system 400 via network 600.

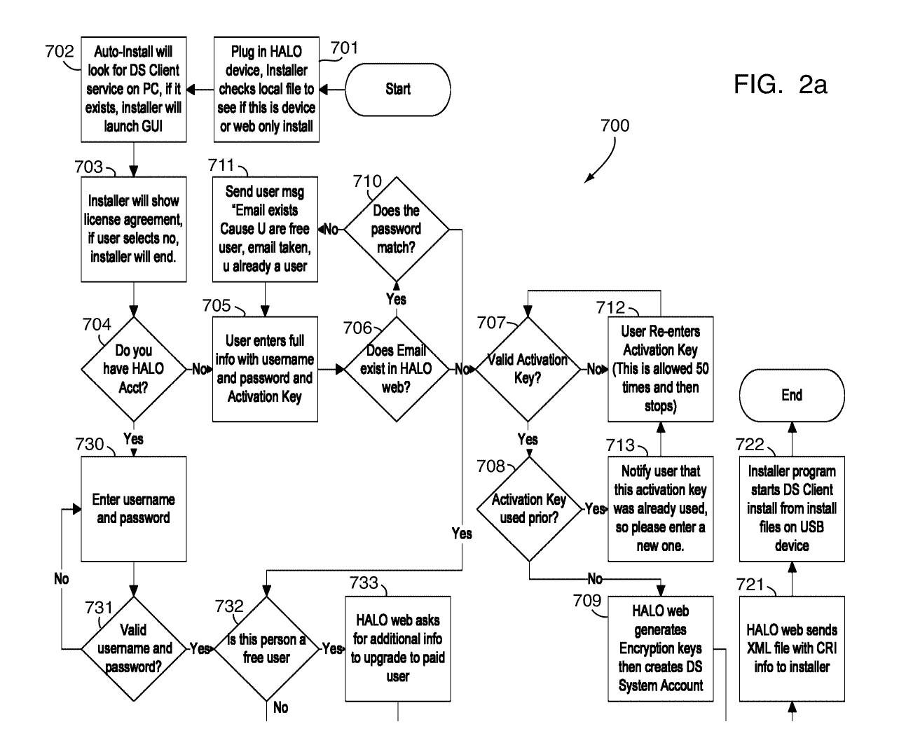

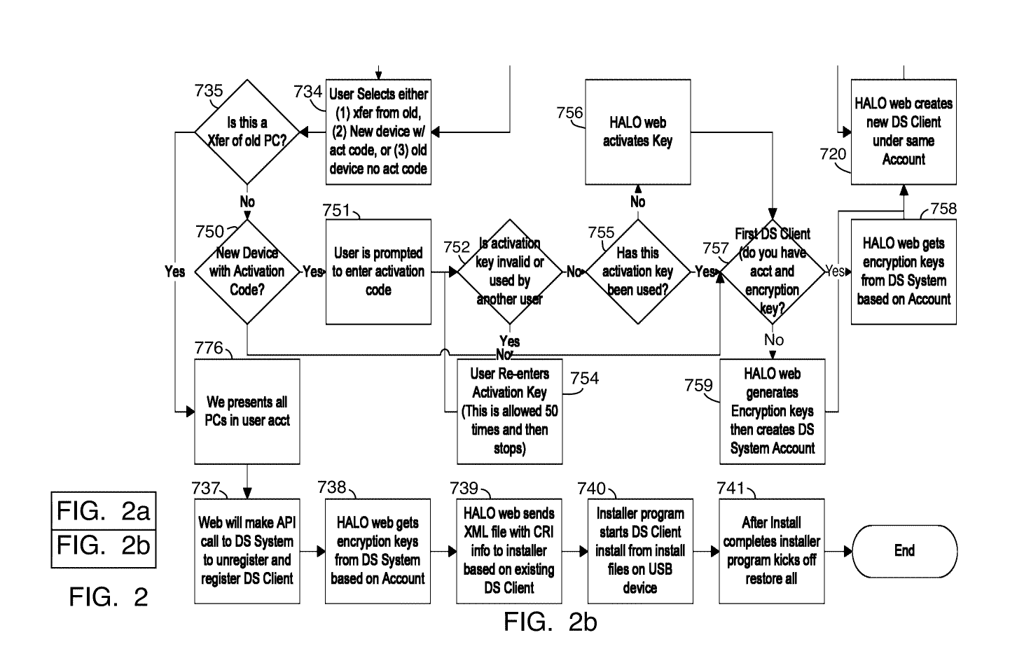

Local backup device 200 is preferably a backup drive that is adapted to connect to a client device 300 to transfer data to and from client device 300. For example, local backup device 200 may be a USB™ drive or an external disk drive. Local backup device 200 may be adapted to connect to client device 300 via a wired or wireless connection 210, such as, for example, USB™, FIREWIRE®, WIFI™, BLUETOOTH®, etc. Accordingly, in some embodiments, local backup device 200 may include a USB™ or FIREWIRE® connector that connects to a USB™ or FIREWIRE® port in client device 300. Local backup device 200 stores a DS Client Installer Program 220, which is automatically executed when local backup device 200 is connected to client device 300. Local backup device 200 automatically launches DS Client Installer Program 220 to install DS Client Software 310 on client device 300. DS Client Installer Program 220 installs DS Client Software 310 on client device 300 in accordance with an installation routine that is described in more detail below with reference to FIG. 2. Preferably, DS Client software 310 is specifically associated with an online backup service provided by remote backup system 400.

Client device 300 may be any electronic device that stores data, which a client wishes to backup to local backup device 200 and/or remote backup system 400. Client device 300 is adapted to connect to local backup device 200 via a wired or wireless connection 210, such as, for example, USB™, FIREWIRE®, WIFI™, BLUETOOTH®, etc. Further, client device 300 is adapted to store and execute DS Client Software 310, which is data backup management software that performs scheduled data backups. DS Client Software 310 runs on a schedule to backup data on client device 300 to local backup device 200 and/or remote backup system 400 by sending a copy of the data on client device 300 to local backup device 200, and/or to remote backup system 400 via network 600. Client device 300 is connected to remote backup system 400 via a wired or wireless connection 320 to network 600. Further, client device 300 may include web-browsing capabilities for communications with a web interface of remote backup system 400 via a web browser. Client device 300 may be any type of personal computing device with a network interface, such as, for example, personal computer, smart phone, personal digital assistant (PDA), electronic tablet, etc. Also, client device 300 may be an electronic appliance, such as, for example, refrigerator, thermostat, lighting control, cable box, etc.

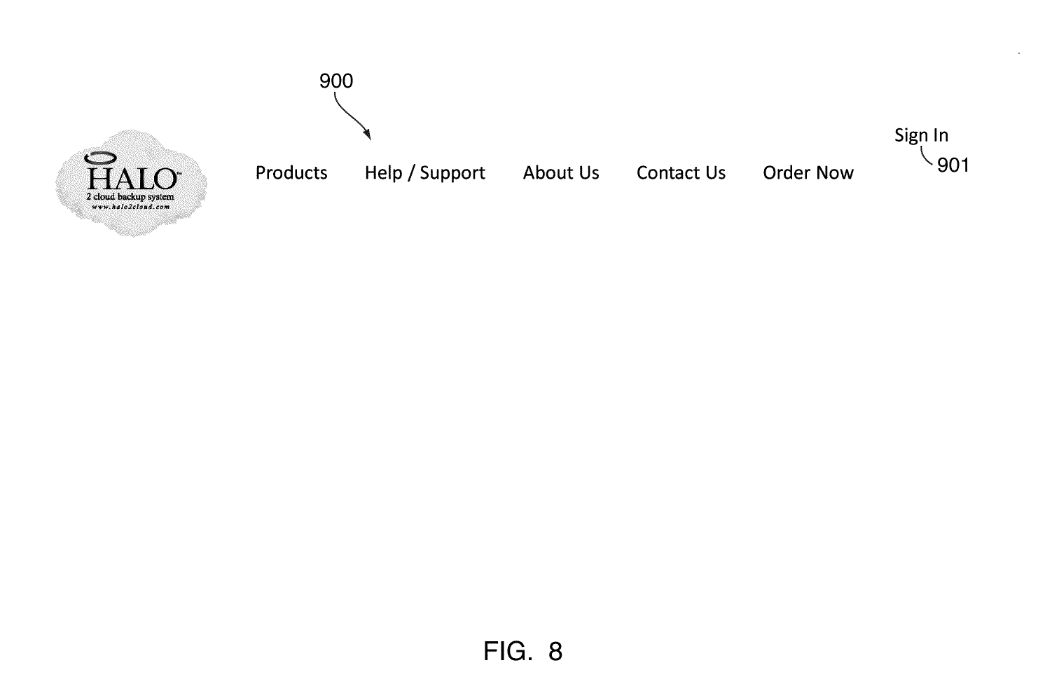

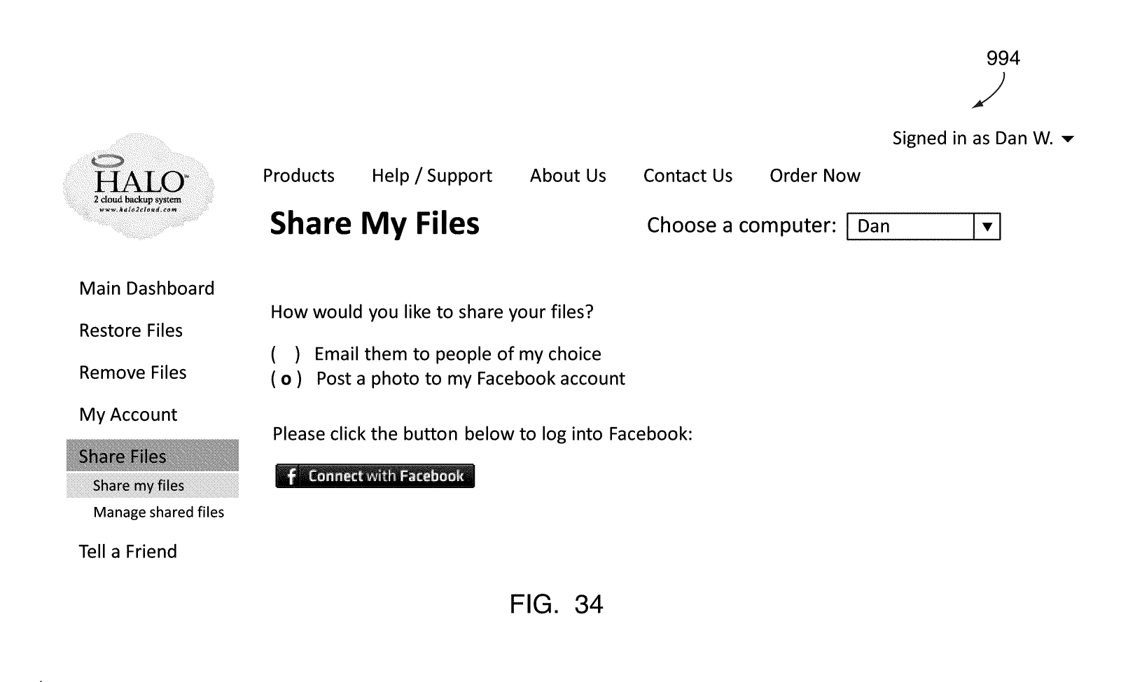

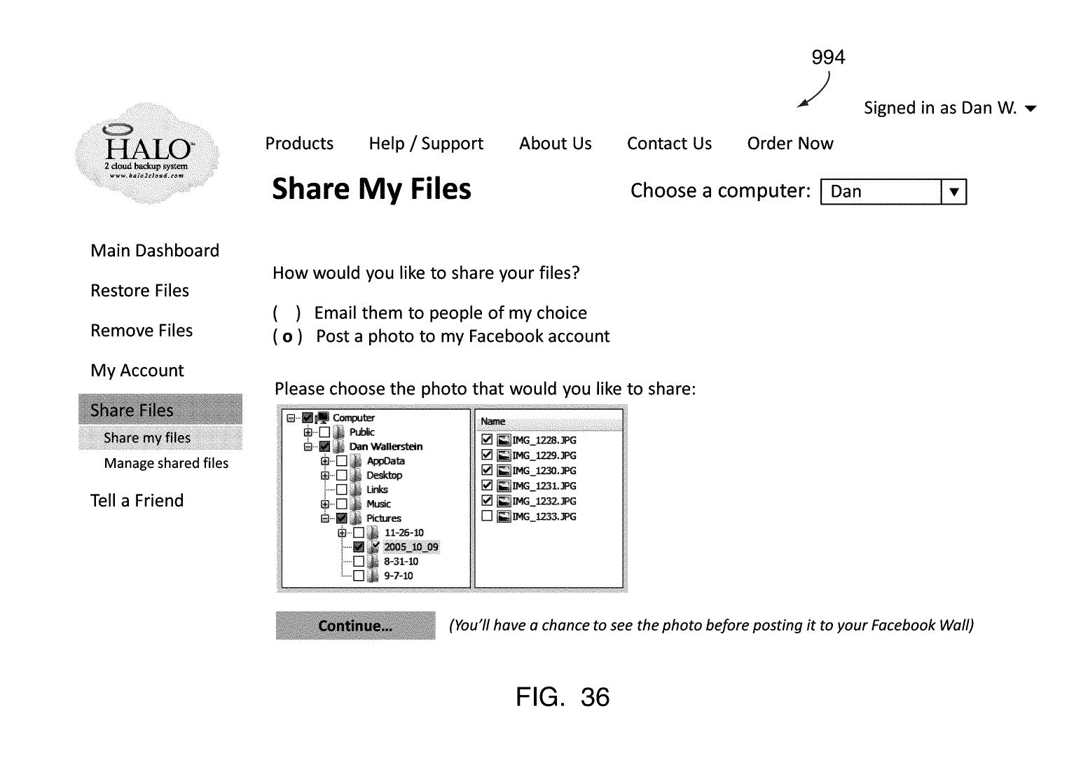

Remote backup system 400 may be a conventional computer, or alternatively, the function of remote backup system 400 may be implemented on a cloud computing system having distributed computer architecture for providing an online/cloud backup service, for backing up data from client devices 300. Remote backup system 400 is connected to client devices 300 and computer devices 500 via network 600. Remote backup system 400 validates, maintains and manages clients' online backup accounts and data storage. Further, remote backup system 400 provides a web portal 410 for allowing clients access to and management of their online backup accounts, including access to and management of remote data backups. The various features and functionalities of remote backup system 400's online backup service are described in more detail below with reference to FIGS. 8-44.

Computer device 500 may be any suitable device that is capable of communication with remote backup system 400's web portal 410 via a web browser, such as a Personal Computer (PC), a portable computing device such as a Personal Digital Assistant (PDA) or smart-phone type device, or any other appropriate storage and/or communication device. Computer device 500 may be, for example, a personal computer, thin client, PDA, smart phone, etc. Computer device 500 may be used to communicate with remote backup system 400 via network 600 and access a client's online backup account through remote backup system 400's web portal 410. Accordingly, a client's online backup account and remote data backups may be accessed using any computer device 500 that is capable of communication with remote backup system 400's web portal 410 via a web browser. Although possible, it is not necessary for a client to use client device 300, whose data is backed up on local backup device 200 and/or remote backup system 400, to access the client's online backup account and remote data backups on remote backup system 400.

Network 600 may be may be one or a combination of a Local Area Network (LAN), a Metropolitan Area Network (MAN), a Wide Area Network (WAN), a proprietary network, a Public Switched Telephone Network (PSTN), a Wireless Application Protocol (WAP) network, a BLUETOOTH® network, a wireless LAN network, and/or an Internet Protocol (IP) network such as the Internet, an intranet, or an extranet.

It should be understood that the methods described herein are exemplary embodiments of the present invention. Accordingly, in other embodiments, additional steps may be added and/or certain steps may be omitted, as desired. Furthermore, the flow charts described herein do not imply a fixed order to the steps, and embodiments of the present invention may be practiced in any order that is practicable. Note that any of the methods described herein may be performed by hardware, software, or any combination of these approaches. For example, a storage medium may store thereon instructions that when executed by a machine result in performance according to any of the embodiments described herein.

In accordance with one aspect of the invention, DS Client Installer Program 220 executes DS Client installation routine 700 to install DS Client Software 310 on client device 200 under various scenarios. DS Client installation routine 700 is described herein with reference to FIG. 2. Preferably, DS Client Installer Program 220 automatically executes DS Client installation routine 700 when local backup device 200 is connected to client device 300.

In step 701, after local backup device 200 is connected to client device 300, DS Client Installer Program 220 checks a local file that indicates whether the DS Client installation is a local backup device 200 installation or a web only installation. In step 702, DS Client Installer Program 220 checks for DS Client service on client device 300, and if DS Client service exists, DS Client Installer Program 220 launches a graphical user interface (GUI) for presenting information to the user and receiving information from the user. In step 703, DS Client Installer Program 220 displays a user license agreement. If the user declines the user license agreement in step 703, then DS Client installation routine 700 is terminated. If the user accepts the user license agreement in step 703, then the user proceeds to step 704, where DS Client Installer Program 220 asks whether the user has an existing online backup account with remote backup system 400.

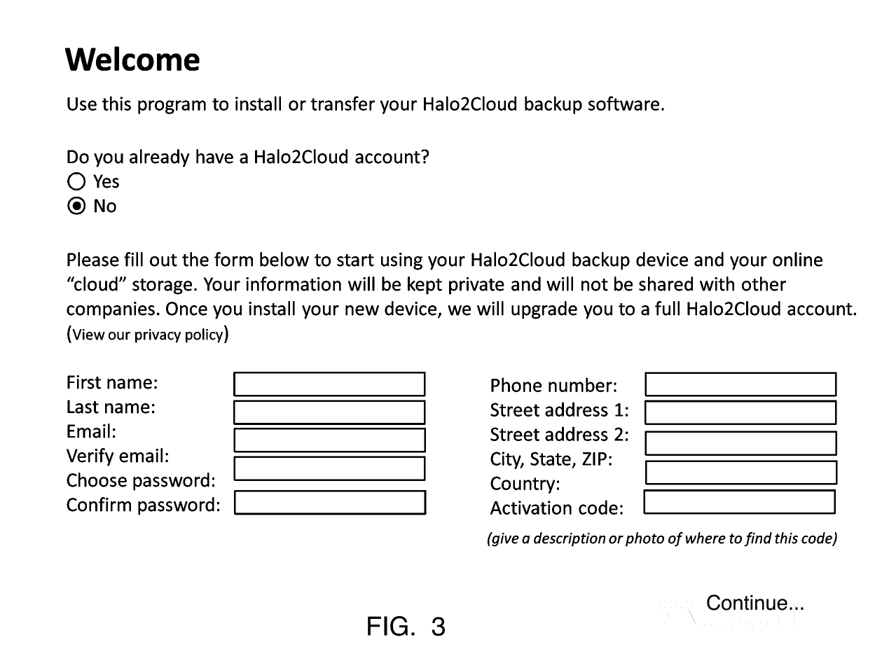

If the user indicates that he does not have an existing account, then the user proceeds to step 705 where DS Client Installer Program 220 requests information for setting up a new account, including name, email, desired password, phone number, address, and activation code. The activation code is provided with local backup device 200 and is unique to local backup device 200. FIG. 3 shows an exemplary GUI for collecting new account setup information in step 705. The information collected in step 705 is sent to remote backup system 400 via client device 300's connection 320 to network 600. For example, DS Client Installer Program 220 may send the following API call to remote backup system 400:

registration::add_user_and_add_client(

web_only_install, // 0 for “no”
fname,
lname,
email,
pword,
phone,
street1,
street2,
city,
state,
zip,
country,
activation_code

);

DS Client Installer Program 220 communicates with remote backup system 400 via client device 300's connection 320 to network 600. In step 706, DS Client Installer Program 220 communicates with remote backup system 400 to determine whether the email address provided by the user is already in use. If the email address is not already in use, DS Client Installer Program 220 communicates with remote backup system 400 in step 707 to confirm that the activation code provided by the user is valid. If, in step 707, it is determined that the activation code is valid, then DS Client Installer Program 220 communicates with remote backup system 400 in step 708 to determine whether the activation code has been previously used. If, in step 708, it is determined that the activation code has not been previously used, then remote backup system 400 generates encryption keys and creates an online backup account in step 709. In step 710, remote backup system 400 creates a new DS Client under the same online backup account created in step 709. In step 721, remote backup system 400 sends an XML file with CRI information to DS Client Installer Program 220. The following is an exemplary XML file:

<xml>

<status>0</status>
<user_name>Dan Wallerstein</user_name>
<account_name>HALOQVC12736</account_name>
<client_number>DSC000100002</client_number>
<system_address>50.56.24.234</system_address>
<encryption_key>QW4gZmFudGFzdGlijlGVuY3J5cHRpb24ga2V5</encryption_key>

</xml>

In step 722, DS Client Installer Program 220 starts DS Client Software 310 installation on client device 300 from installation files on local backup device 200.

If, in step 706, it is determined that the email address provided by the user in step 705 is already in use, then DS Client Installer Program 220 communicates with remote backup system 400 in step 710 to determine whether the password provided by the user in step 705 matches the existing password for the email address. If, in step 710, it is determined that the password matches the email address, then DS Client Installer Program 220 proceeds to step 732 described below. If, in step 710, it is determined that the password does not match the email address, an error message is displayed and the user is prompted to provide the correct password. For example, if it is determined that the password does not match the email address, then remote backup system 400 may send the following XML file to DS Client Installer Program 220:

<xml>

<status>1</status>
<show_message>The email address or password that you entered
is incorrect. Please try again, or <a
href=\“http://www.halo2cloud.com/forgot_password\”>
click here</a> if you forgot your password. For security reasons,
your account will be blocked for one hour after another 3
unsuccessful login attempts.</show_message>

</xml>

If, in step 707, it is determined that the activation code provided by the user in step 705 is not valid, an error message is displayed and the user is prompted to provide a valid activation code in step 712. In step 712, the user is allowed up to fifty attempts to provide a valid activation code and then the DS Client installation routine 700 is terminated. If, in step 708, it is determined that the activation code provided by the user in step 705 was previously used, an error message is displayed and the user is prompted to provide a new valid activation code in steps 712 and 713. In steps 712 and 713, the user is allowed up to fifty attempts to provide a new valid activation code and then the DS Client installation routine 700 is terminated.

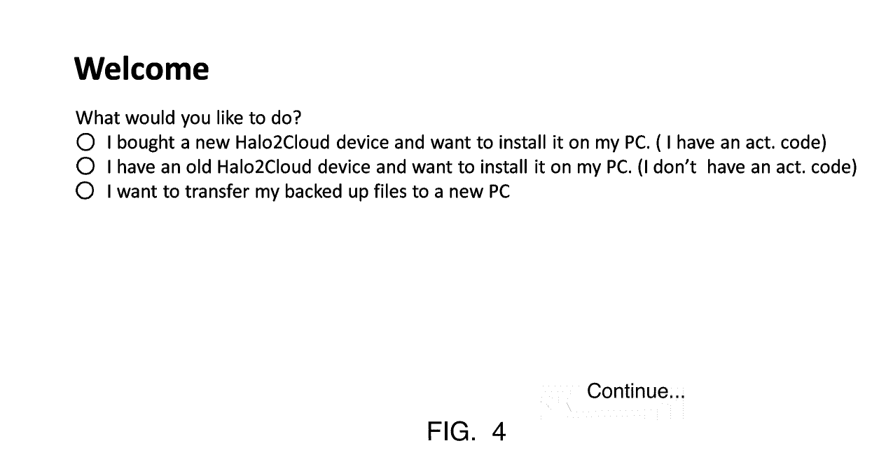

If, in step 704, the user indicates that he has an existing account, then DS Client Installer Program 220 prompts the user in step 730 to provide the username and password for the account. In step 731, DS Client Installer Program 220 communicates with remote backup system 400 to determine whether the username and password are valid. If the user name and password are invalid, an error message is displayed and the user is prompted to enter a valid username and password. The user is allowed up to three attempts to provide a valid username and password and then the account is blocked. If the username and password are valid, DS Client Installer Program 220 communicates with remote backup system 400 in step 732 to determine whether the user is a free user. If, in step 732, it is determined that the user is a free user, remote backup system 400 prompts the user for additional information to upgrade the user to paid user. If, in step 732, it is determined that the user is a paid user, DS Client Installer Program 220 in step 734 prompts the user to select whether: 1) user has a new local backup device 200 (with activation code) to be installed on client device 300; 2) user has an old local backup device (without activation code) 200 to be installed on client device 300; 3) user wants to transfer backed up files to new client device 300. FIG. 4 shows an exemplary GUI used in connection with step 734.

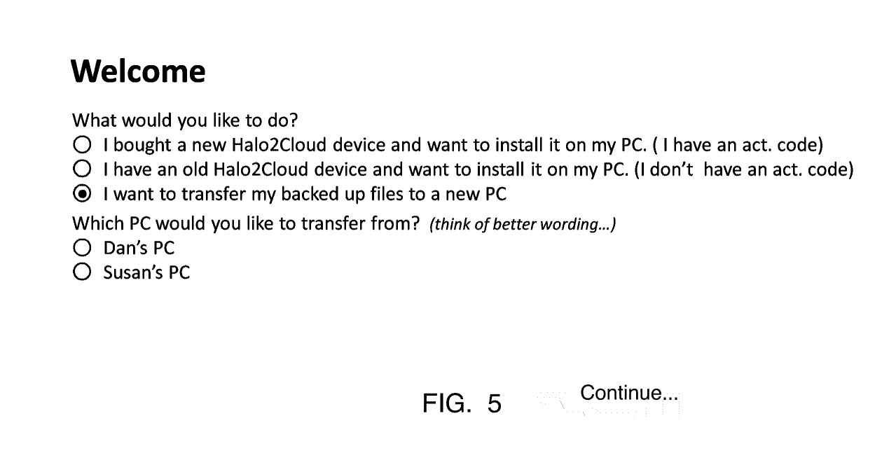

If DS Client Installer Program 220 determines in step 735 that the DS Client Software 310 installation is for a transfer of backed up files to a new client device 300, then remote backup system 400 presents all client devices under the existing online backup account in step 736. FIG. 5 shows an exemplary GUI used in connection with step 736. In step 737, DS Client Installer Program 220 may make an API call to remote backup system 400 to unregister and register DS Client Software 310. In step 738, remote backup system 400 retrieves encryption keys based on information about the existing online backup account. In step 739, remote backup system 400 sends an XML file with CRI information to DS Client Installer Program 220 based on an existing online backup account. The following is an exemplary XML file:

<xml>

<status>0</status>
<account_name>HALOQVC12736</account_name>
<encryption_key>QW4gZmFudGFzdGljlGVuY3J5cHRpb24ga2V5</encryption_key>
<system_address>50.56.24.234</system_address>
<ds_clients>

<item>

<device_name>Dan\'s PC</device_name>
<user_name>Dan Wallerstein</user_name>
<client_number>DSC000100002</client_number>

</item>
<item>

<device_name>Susan\'s PC</device_name>
<user_name>Dan Wallerstein</user_name>
<client_number>DSC000100007</client_number>

</item>

</ds_clients>

</xml>

In step 740, DS Client Installer Program 220 starts DS Client Software 310 installation on client device 300 from installation files on local backup device 200. In step 741, after installation of DS Client Software 310 on new client device 300 is complete, DS Client Software 310 executes restore all function.

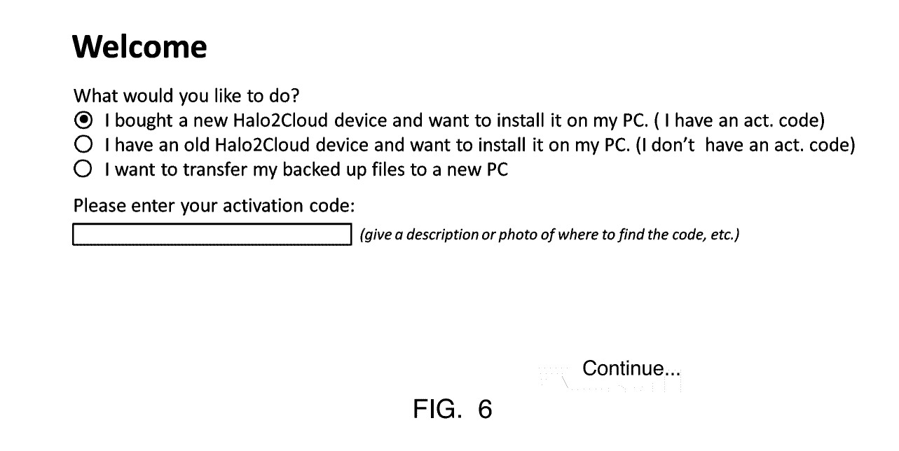

If, in step 735, DS Client Installer Program 220 determines that the DS Client Software 310 installation is not for a transfer of backed up files to a new client device 300, then, in step 750, DS Client Installer Program 220 determines whether the DS Client Software 310 installation is for a local backup device 200 with an activation code or without an activation code. If the DS Client Software 310 installation is for a local backup device 200 with an activation code, then DS Client Installer Program 220 prompts the user for an activation key in step 751. FIG. 6 shows an exemplary GUI used in connection with step 751. In step 752, DS Client Installer Program 220 communicates with remote backup system 400 to determine whether the activation code is valid. If the user name and password are invalid, an error message is displayed and the user is prompted to enter a valid username and password. The user is allowed up to three attempts to provide a valid username and password and then the account is blocked. If, in step 750, it is determined that the DS Client Software 310 installation is for a local backup device 200 without an activation code, DS Client installation routine 700 proceeds to step 757 described in detail below.

If, in step 752, it is determined that the activation code provided by the user in step 751 is not valid or is used by another user, an error message is displayed and the user is prompted to provide a valid activation code in step 754. The user is allowed up to fifty attempts to provide a valid activation code and then the DS Client installation routine 700 is terminated.

If, in step 752, it is determined that the activation code provided by the user in step 751 is valid, DS Client Installer Program 220 communicates with remote backup system 400 in step 755 to determine whether the activation code has been previously used. If it is determined that the valid activation code has been previously used, DS Client Installer Program 220 communicates with remote backup system 400 in step 757 to determine whether there is an account and encryption key associated with DS Client software 310. If it is determined in step 755 that the valid activation code has not been previously used, remote backup system 400 activates the activation code in step 756 and DS Client installation routine 700 proceeds to step 757 to determine whether there is an account and encryption key associated with DS Client software 310. If, in step 757, it is determined that there is an account and encryption key associated with DS Client software 310, remote backup system 400 retrieves the encryption keys based on information about the existing online backup account. If, in step 757, it is determined that there is no account or encryption key associated with DS Client software 310, remote backup system 400 generates encryption keys and creates a new online backup account. After either step 758 or 759, DS Client installation routine 700 proceeds to steps 720-722 as previously described above.

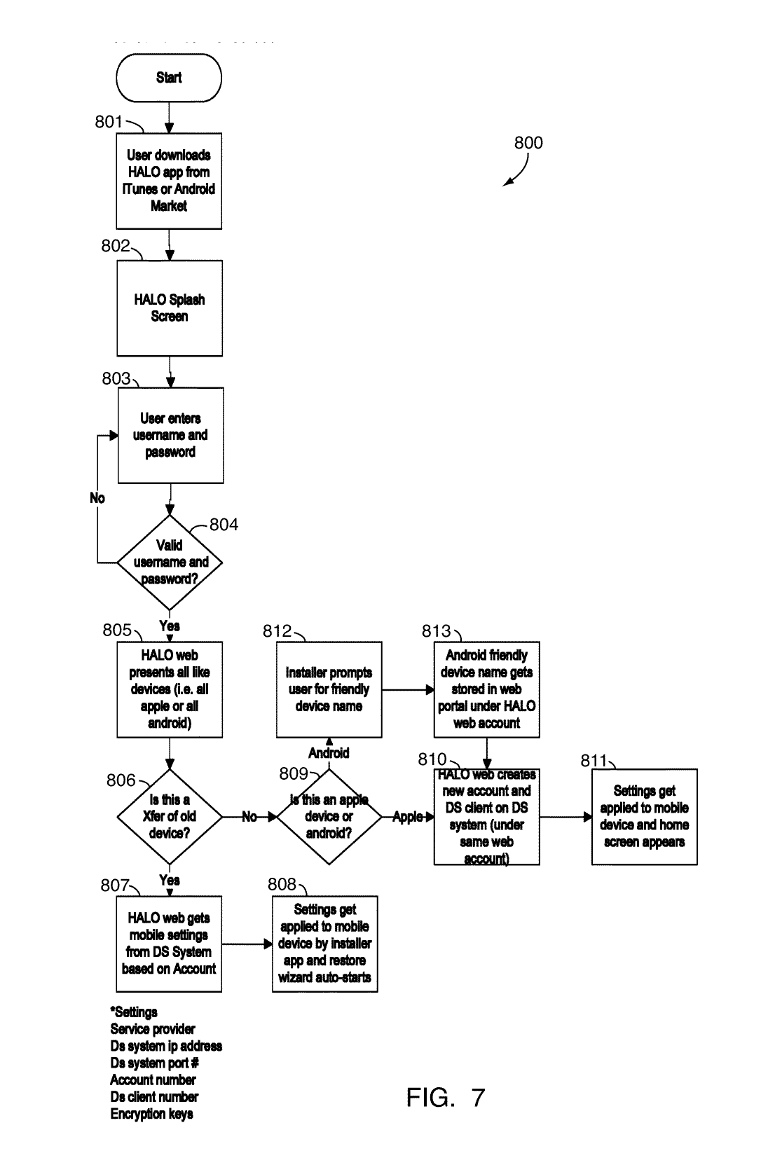

In accordance with another aspect of the invention, DS Mobile Client application 310′ may be installed on client device 300′ (e.g., smart phone) via the web in accordance with installation routine 800. DS Mobile Client installation routine 800 is described herein with reference to FIG. 7.

In step 801, user sends a request from client device 300′ to download DS Mobile Client application 310′ from ITUNES® or ANDROID MARKET™ and DS Mobile Client application 310′ is installed on client device 300′. In step 802, DS Mobile Client application 310′ presents a splash screen. In step 803, DS Mobile Client application 310′ prompts user to enter a user name and password. In step 804, DS Mobile Client application 310′ communicates with remote backup system 400 via network 600 to determine whether the username and password are valid. If, in step 804, the username and password are determined to be invalid, an error message is displayed and the user is prompted to enter a valid username and password. The user is allowed up to three attempts to provide a valid username and password and then the account is blocked. If the username and password are valid, DS Mobile Client application 310′ presents all like devices (i.e., all APPLE® or all ANDROID™ devices) in step 805 and prompts the user to identify client device 300′ from the list. In step 806, DS Mobile Client application 310′ asks the user whether the installation of DS Mobile Client application 310′ is to transfer backed up files to new client device 300′. If the installation of DS Mobile Client application 310′ is to transfer backed up files to new client device 300′, DS Mobile Client application 310′ communicates with remote backup system 400 via network 600 in step 807 to get mobile settings from the existing online backup account. In step 808, the mobile settings from the existing online backup account are applied to client device 300′ by DS Mobile Client application 310′ and restore wizard is executed automatically by DS Mobile Client application 310′.

If, in step 806, it is determined that the installation of DS Mobile Client application 310′ is not to transfer backed up files to new client device 300′, DS Mobile Client application 310′ in step 809 asks the user whether client device 300′ is an APPLE® device or an ANDROID™ device. If client device 300′ is an APPLE® device, remote backup system 400 creates a new online backup account, which includes DS Mobile Client application 310′. In step 811, settings are applied to client device 300′ and home screen is launched. If client device 300′ is an ANDROID™ device, DS Mobile Client application 310′ prompts user for friendly device name in step 812. In step 813, ANDROID™ friendly device name gets stored in remote backup system 400's web portal 410 under a new online backup account. After step 813, DS Mobile Client installation routine 800 proceeds with steps 810-811 as described above.

In accordance with another aspect of the invention, remote backup system 400 comprises a web portal 410 which the user can access via a web interface using client device 300 or computer device 500. Remote backup system 400 is configured to communicate with DS Client Software 310 on device 300 to coordinate online backup of data stored in client device 300 to remote backup system 400. Further, remote backup system 400 maintains, manages and validates the online backup accounts for storing backed up data that transmitted by the DS Client Software 310. By connecting to remote backup system 400 with a connection to network 600 and a web browser interface, a user can access remote backup system 400's web portal 410 to manage his online backup account, and to backup, store and manage data remotely.

Remote backup system 400's web portal 410 provides various web browser interfaces for a user to manage various aspects of an online backup account. Various web browser interfaces will be described below with reference to FIGS. 8-44.

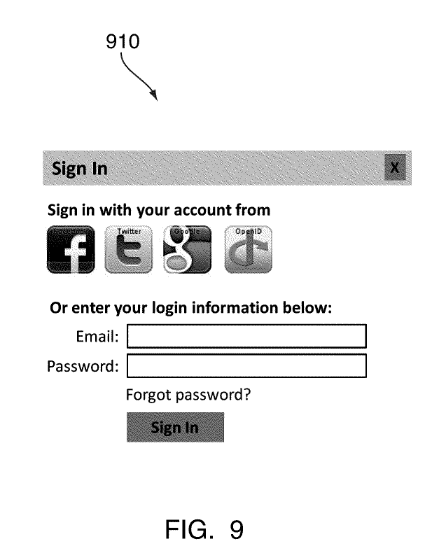

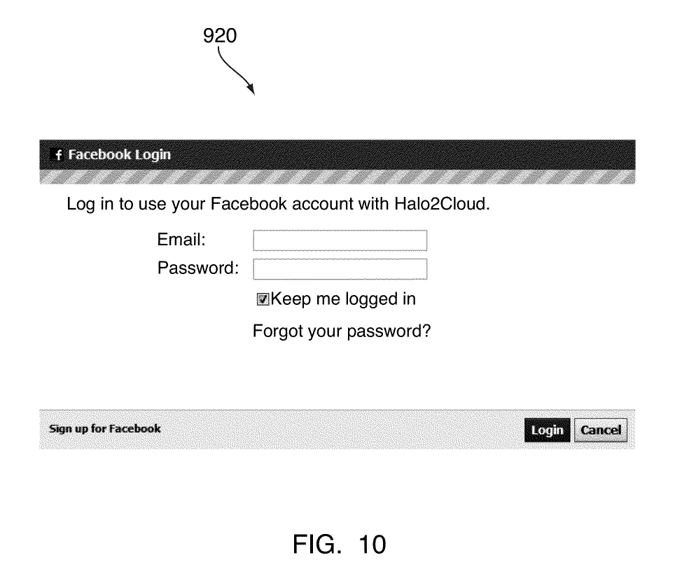

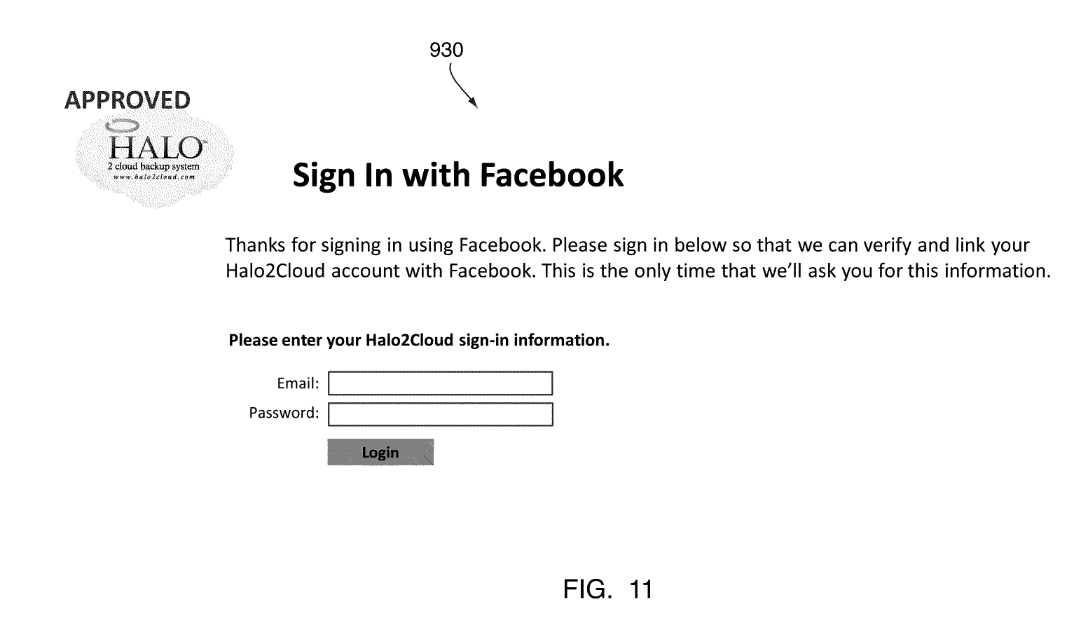

FIG. 8 shows an exemplary web browser interface 900 that a user can use to sign in to his online backup account. As shown, web browser interface 900 includes a sign-in button 901 that the user can select to sign in to his online backup account. FIG. 9 shows an exemplary web browser interface 910 that provides a user with various options to sign in to his online backup account. For example, as shown, a user can sign in using the email address and password associated with the online backup account or by using a FACEBOOK®, TWITTER®, GOOGLE®, YAHOO®, OPENID® account associated with the online backup account. FIG. 10 shows web browser interface 920 for signing into online backup account using a FACEBOOK® account. FIG. 11 shows web browser interface 930 for requesting the email address and password associated with an online backup account, so that the online backup account can be linked with the FACEBOOK® account.

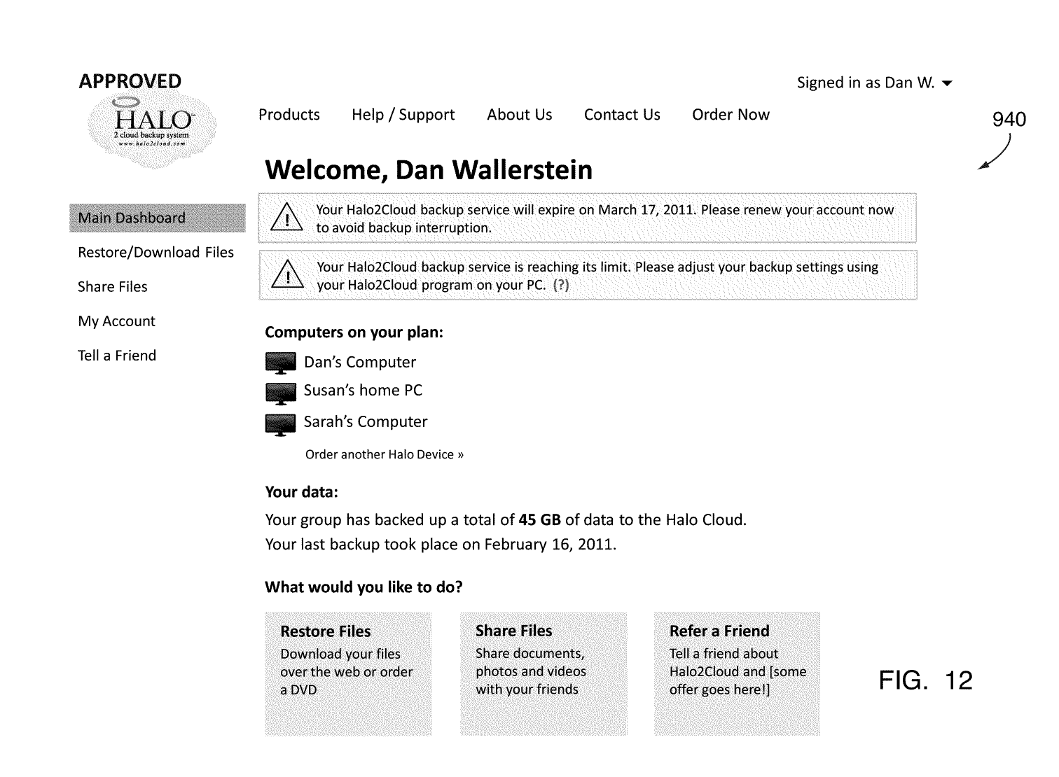

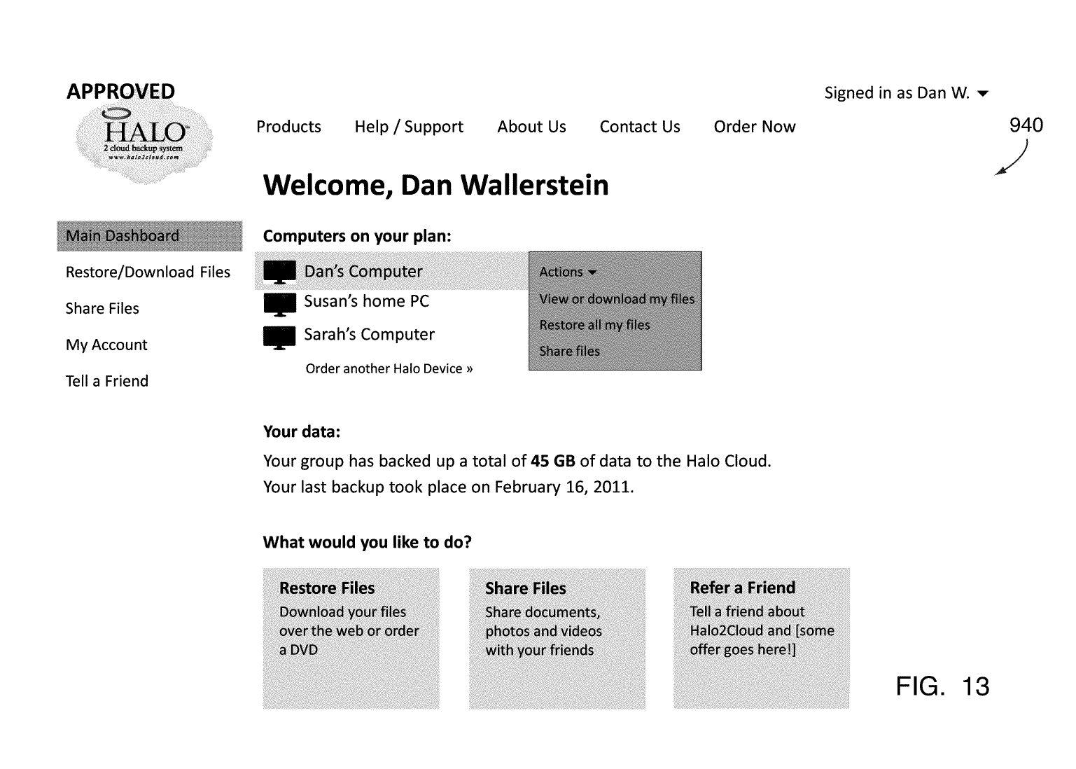

FIG. 12 shows an exemplary web browser interface 940 for displaying the MAIN DASHBOARD of a user's online backup account. As shown in FIG. 12, all of the client devices 300 under the user's online backup account are displayed on the MAIN DASHBOARD. Additionally, various alerts 941, 942 and various status messages 943, 944 regarding the user's online backup account may be displayed on the MAIN DASHBOARD. As shown in FIG. 13, when one of the devices 300 is selected on web browser interface 940, a drop down menu is presented, which includes various actions 945 that can be performed with respect to the selected client device 300. The various actions 945 include viewing or downloading files 946, restoring all files 947 and sharing files 948.

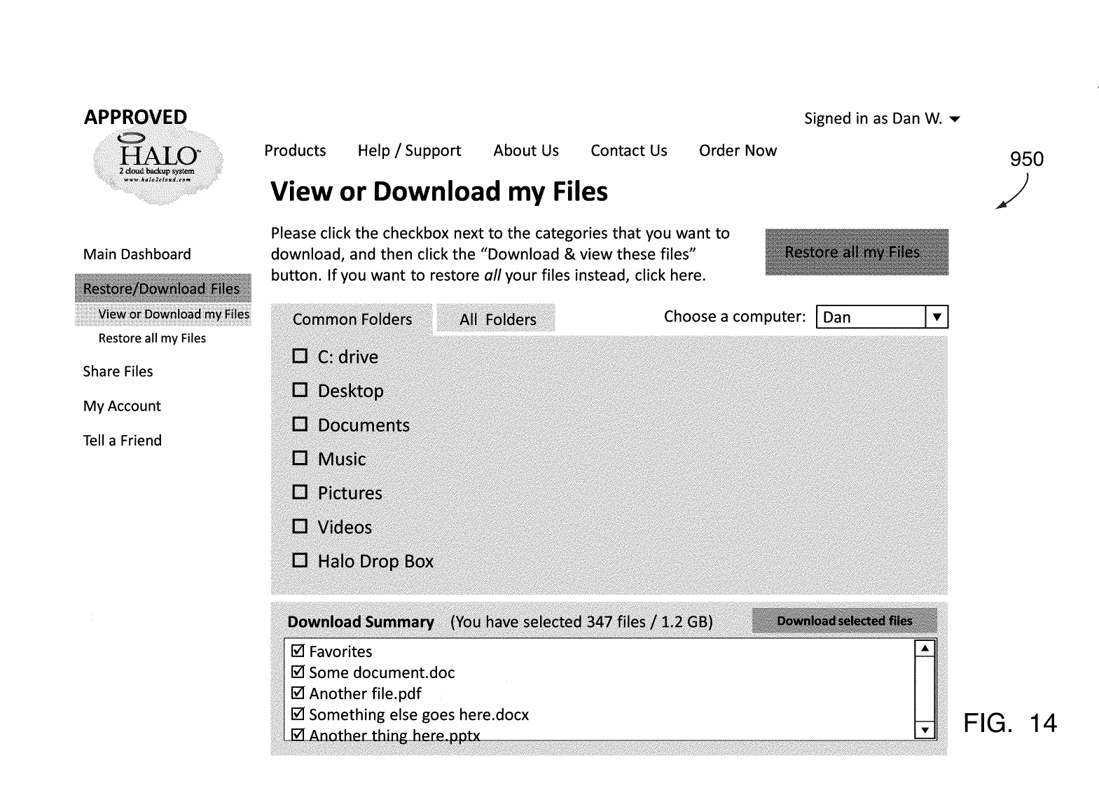

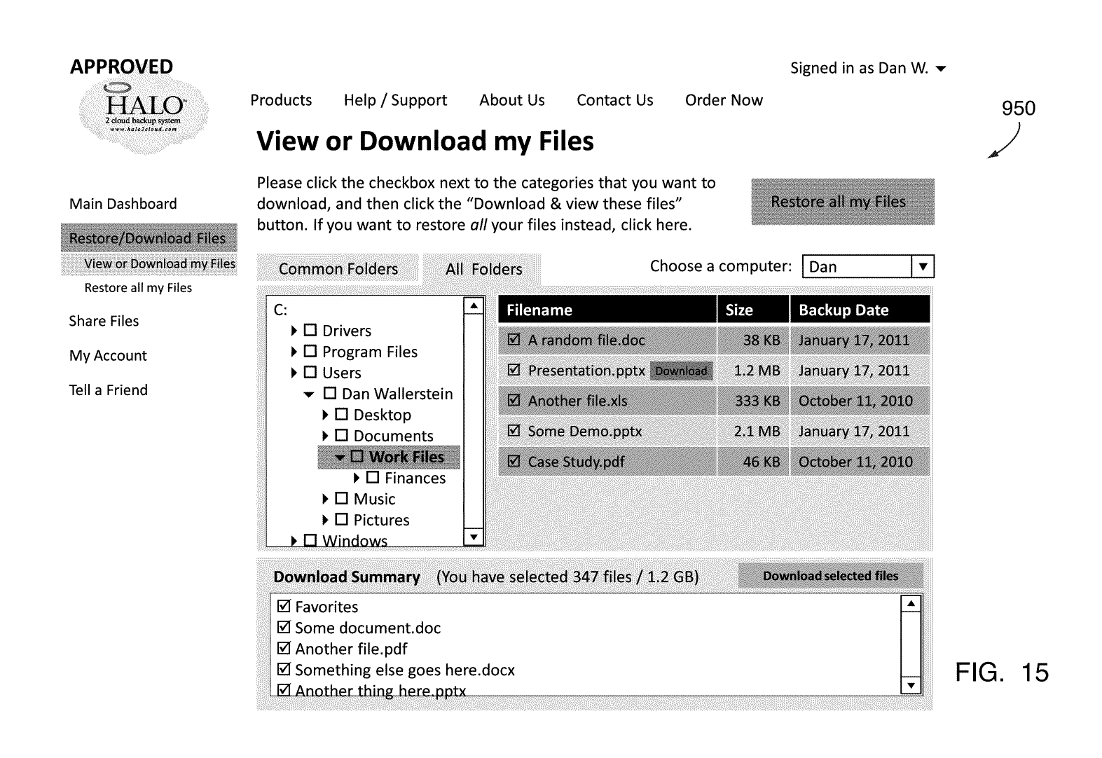

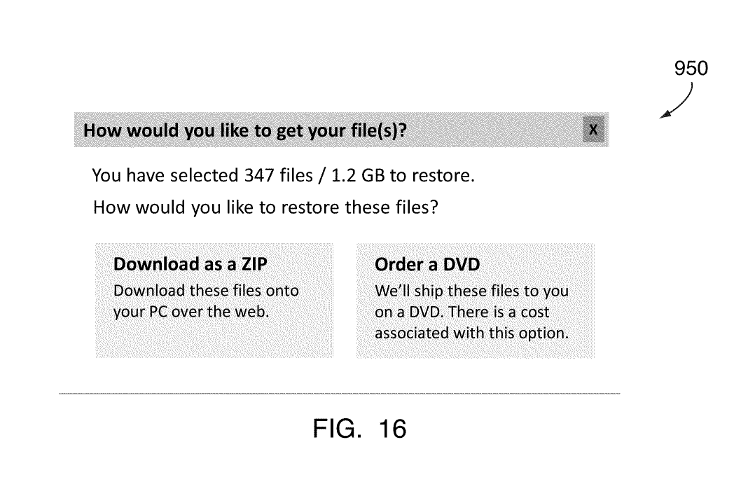

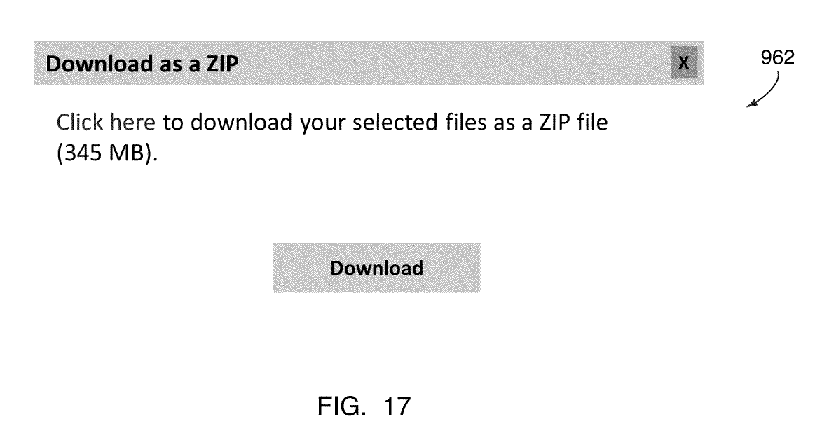

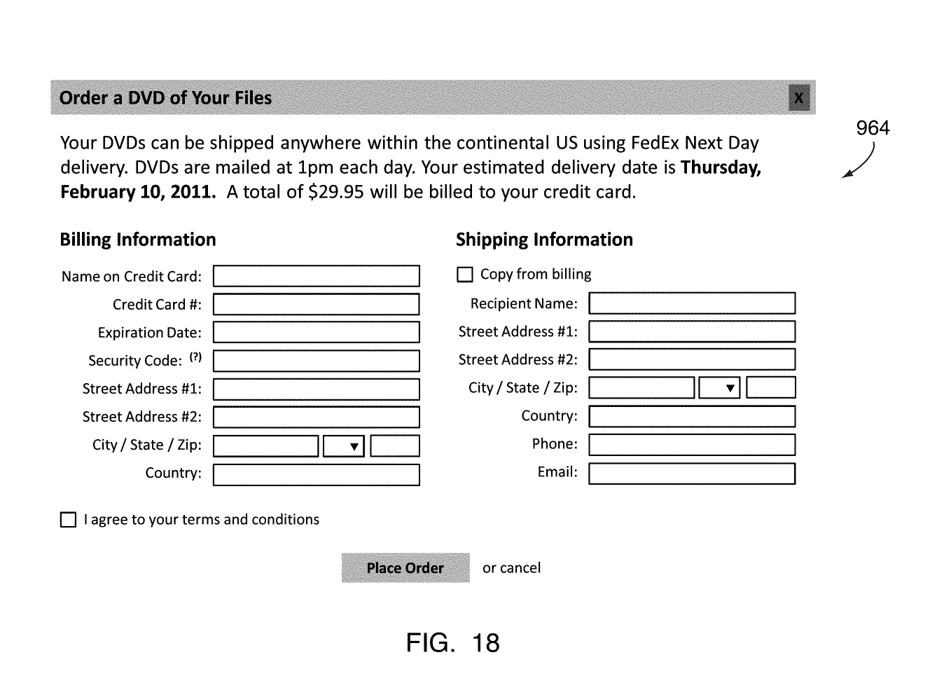

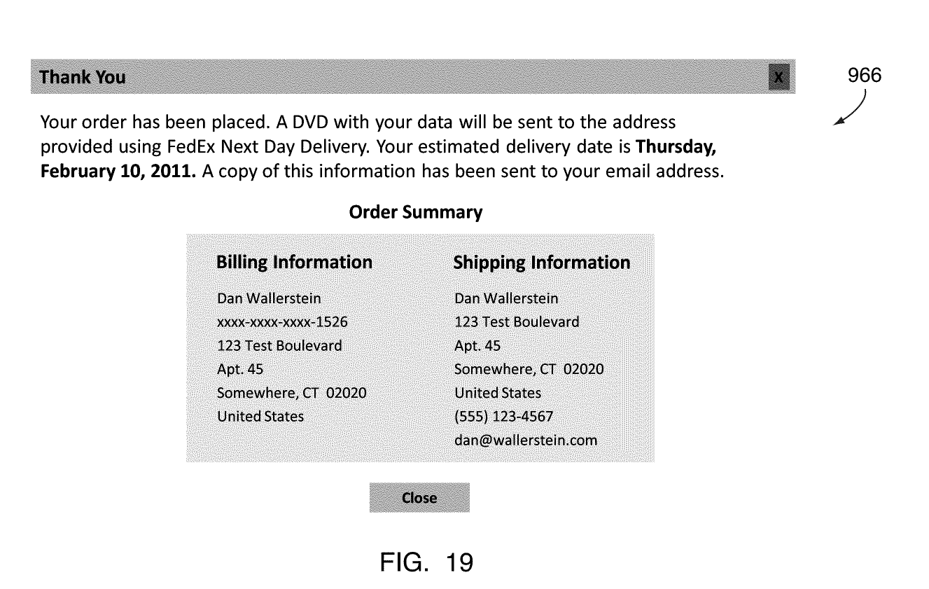

FIGS. 14 and 15 show an exemplary web browser interface 950 for the user to select the files to view or download. As shown in FIGS. 14 and 15, web browser interface 950 includes a file directory for the user to select the files to view or download. FIG. 16 shows an exemplary web browser interface 960 for the user to select whether to download the selected files as a ZIP or to have the selected files shipped on a DVD. FIG. 17 shows an exemplary web browser interface 962 for initiating a ZIP file download of the selected files. FIG. 18 shows an exemplary web browser interface 964 for completing an order form to have the selected files shipped on a DVD. The order form includes fields for billing information and shipping information. FIG. 19 shows an exemplary web browser interface for displaying an order confirmation for shipment of selected files on a DVD.

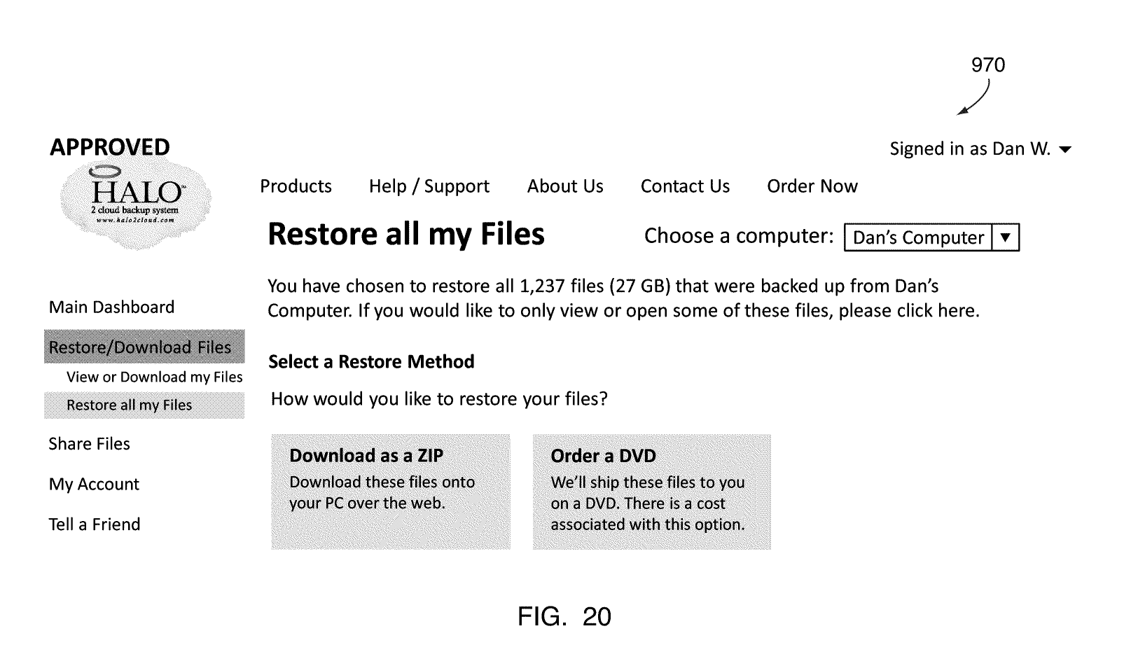

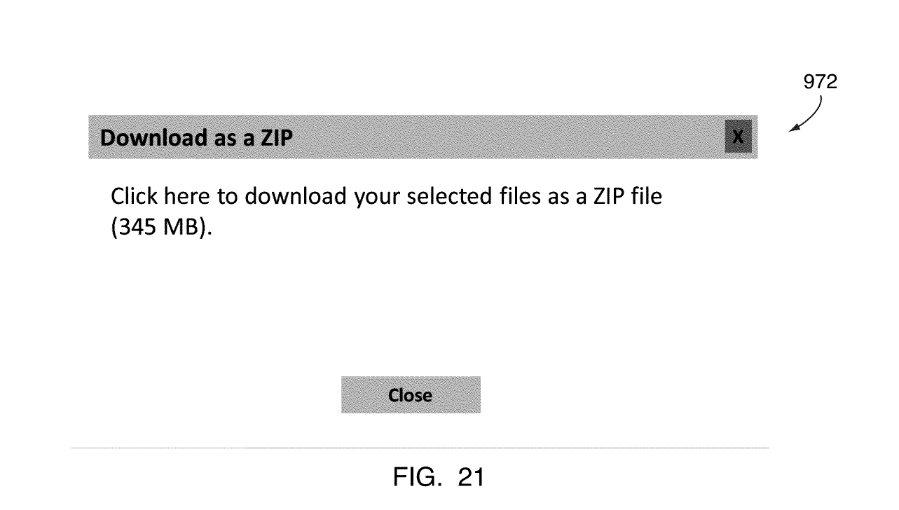

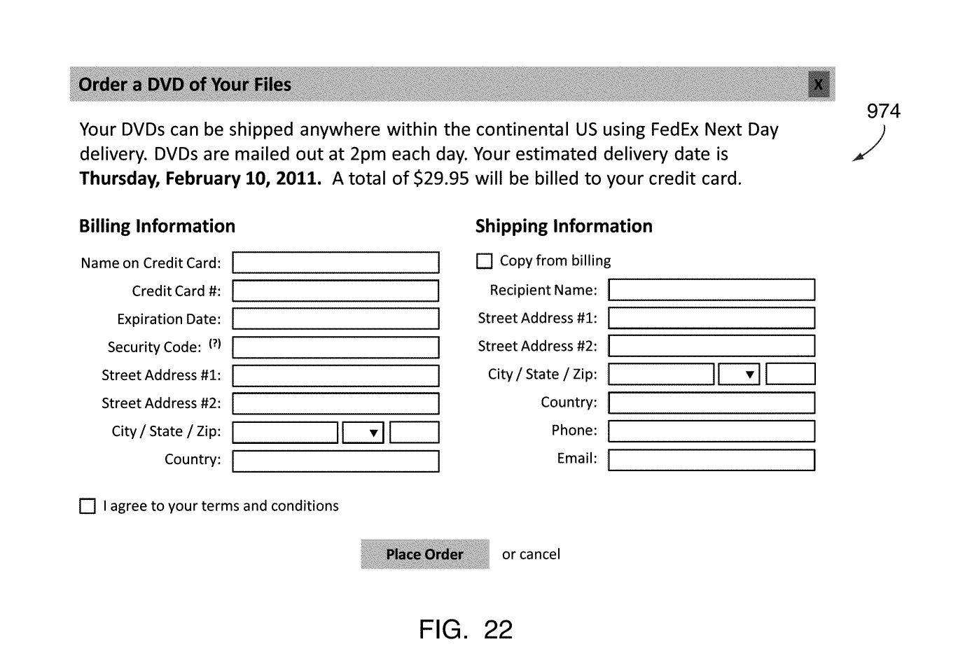

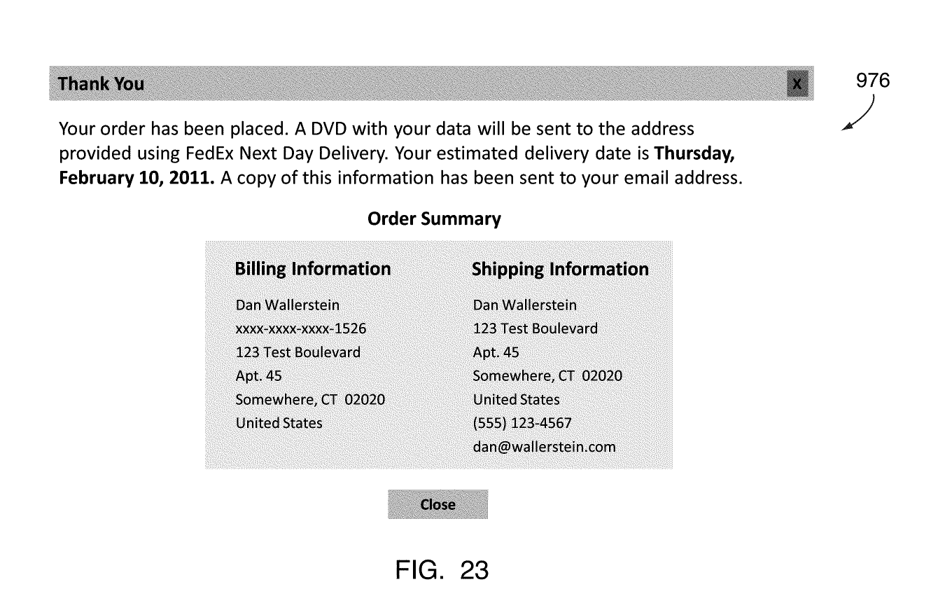

FIG. 20 show an exemplary web browser interface 970 for the user to select to restore all files. As shown in FIG. 20, web browser interface 970 provides the user with the option to download all restored files as a ZIP or to have all restored files shipped on a DVD. FIG. 21 shows an exemplary web browser interface 972 for initiating a ZIP file download of all restored files. FIG. 22 shows an exemplary web browser interface 974 for completing an order form to have all the restored files shipped on a DVD. The order form includes fields for billing information and shipping information. FIG. 23 shows an exemplary web browser interface for displaying an order confirmation for shipment of all the restored files on a DVD.

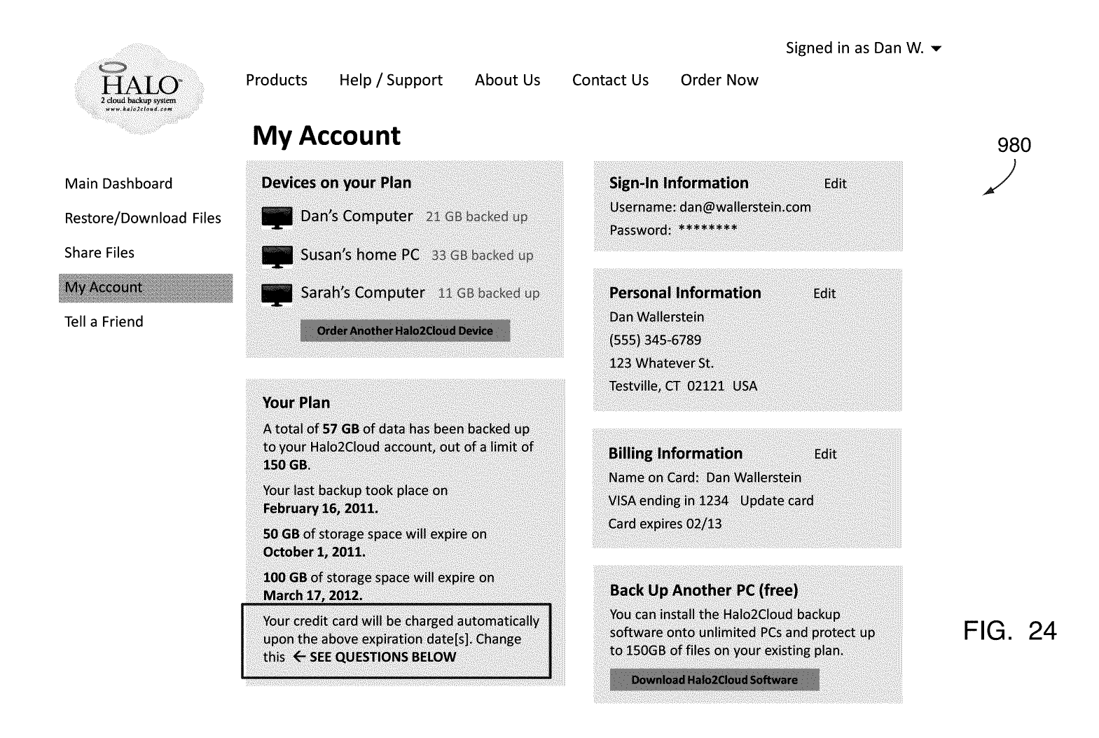

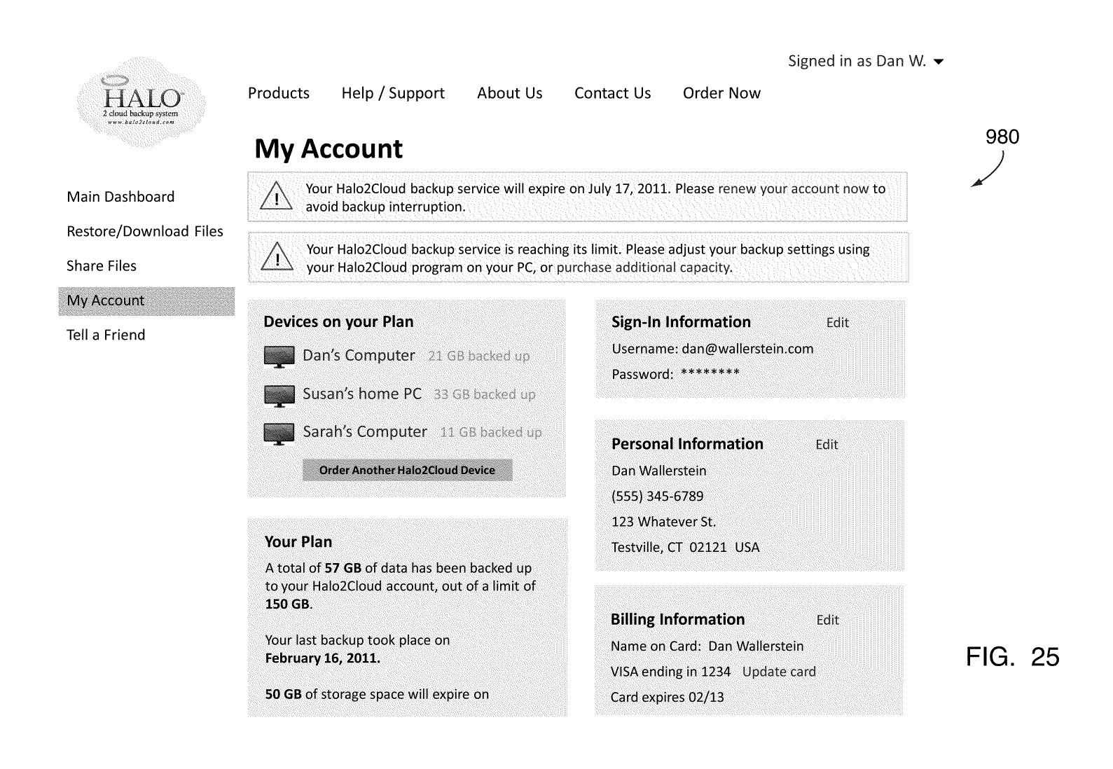

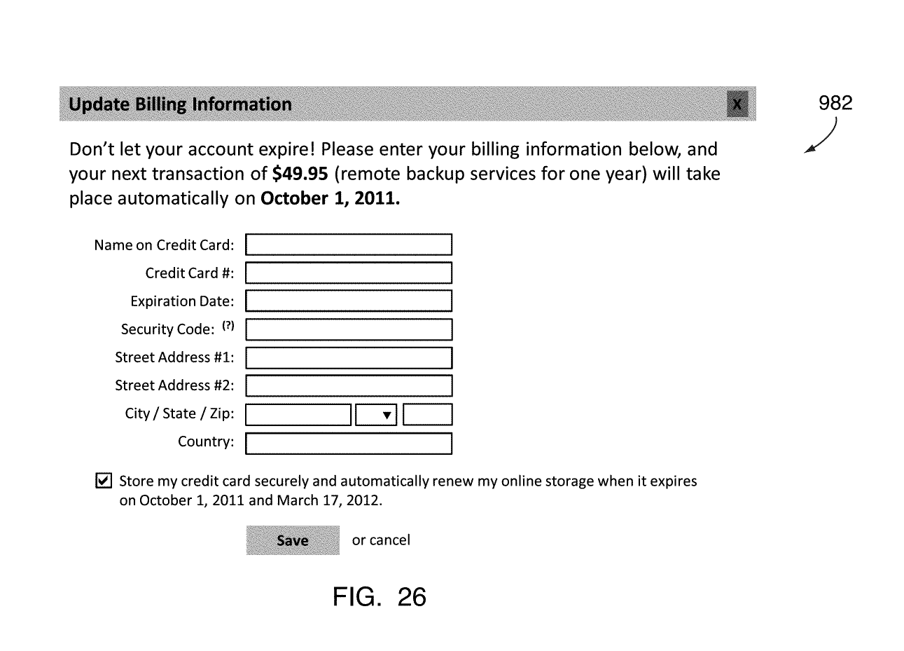

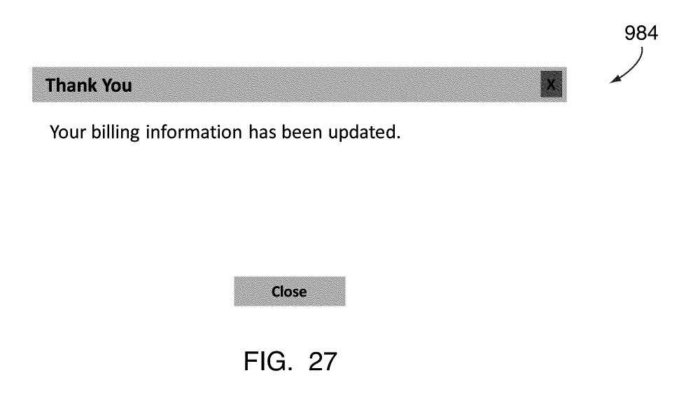

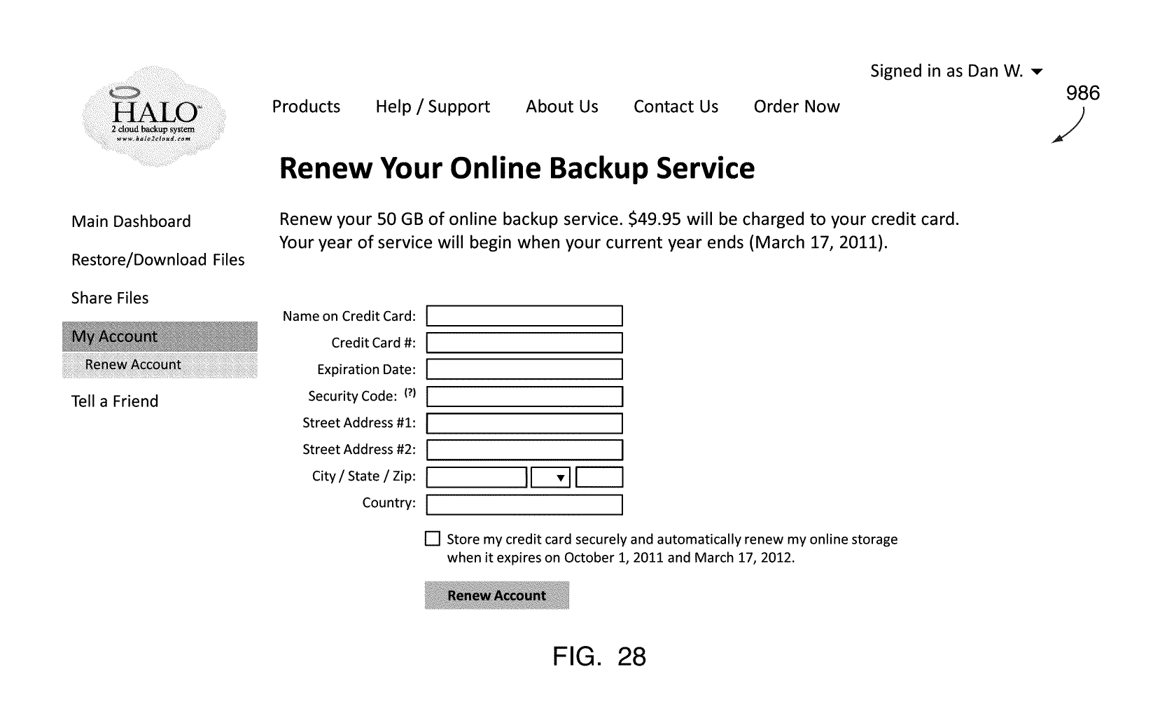

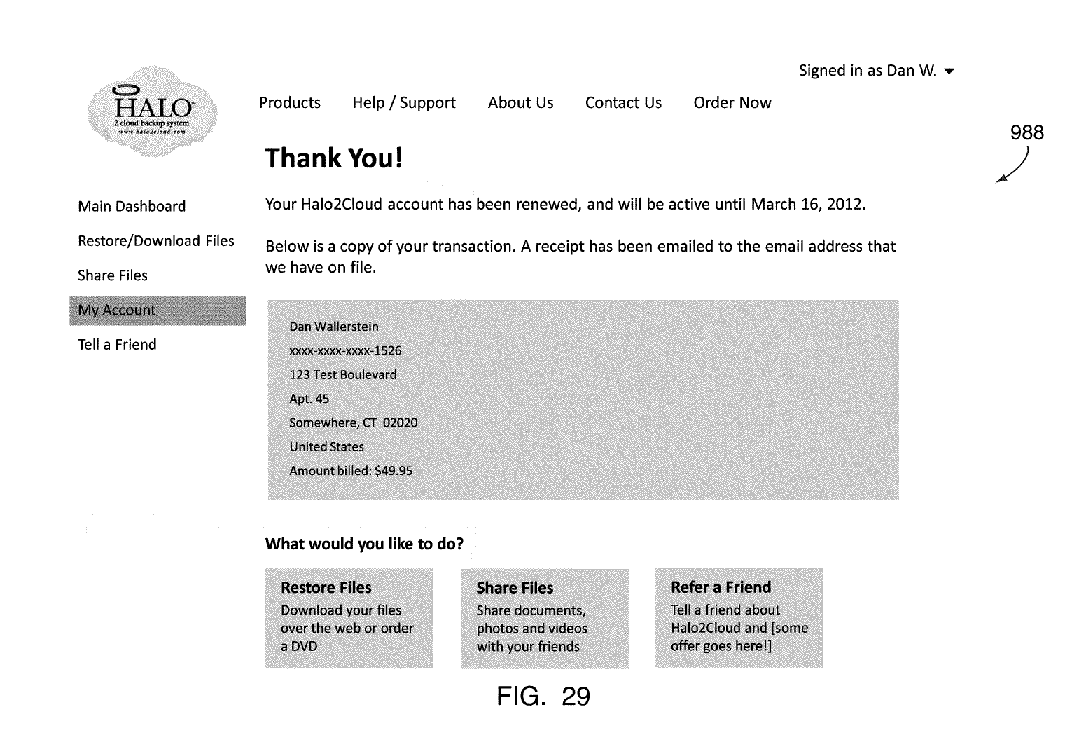

FIGS. 24 and 25 show an exemplary web browser interface 980 for displaying account information for a user online backup account. FIG. 26 shows an exemplary web browser interface 982 for a user to update billing information. FIG. 27 shows an exemplary web browser interface 984 for displaying a confirmation of a billing information update. FIG. 28 shows an exemplary web browser interface 986 for a user to renew online backup service. FIG. 29 shows an exemplary web browser interface 988 for displaying a confirmation of renewal of online backup service.

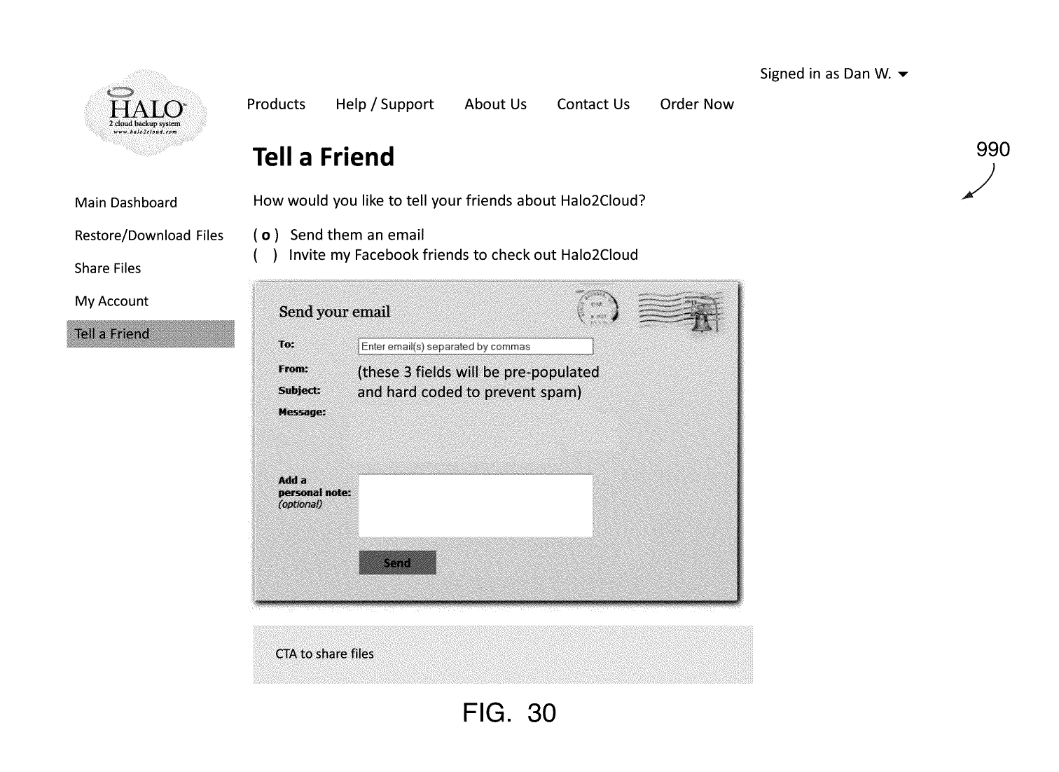

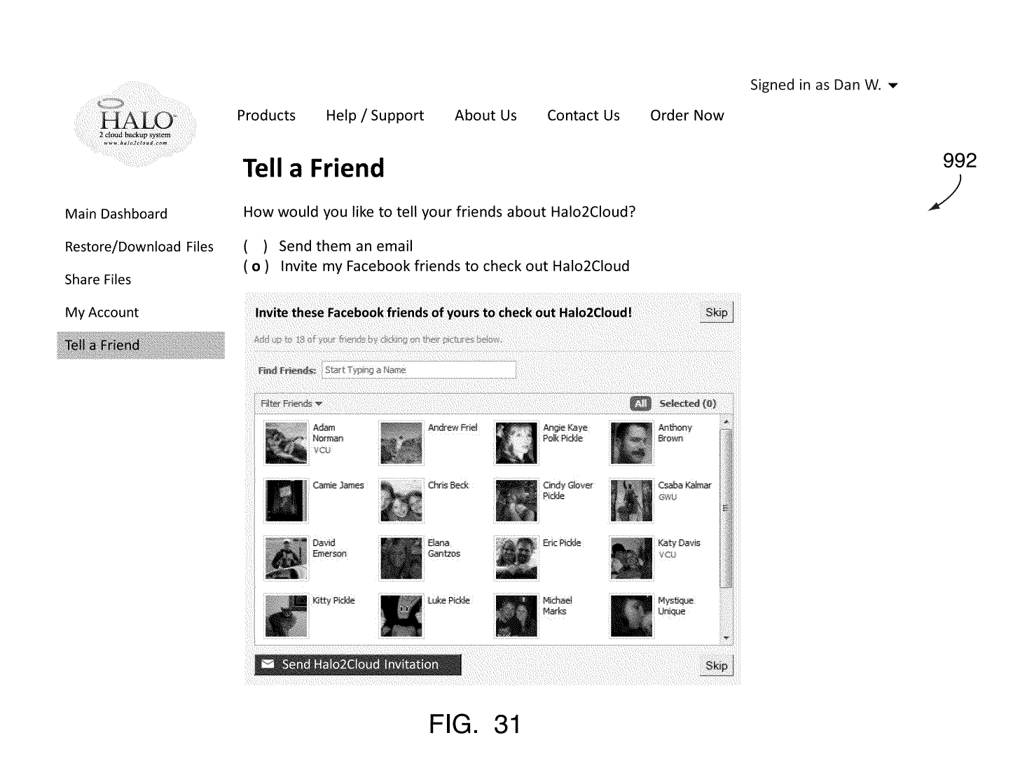

FIGS. 30 and 31 show exemplary web browser interfaces 990, 992 for telling friends about the online backup service. As shown in FIG. 30, web browser interface 990 can be used to share information about the online backup service with friend via email. As shown in FIG. 31, web browser interface 992 can be used to share information about the online backup service with friend via FACEBOOK®.

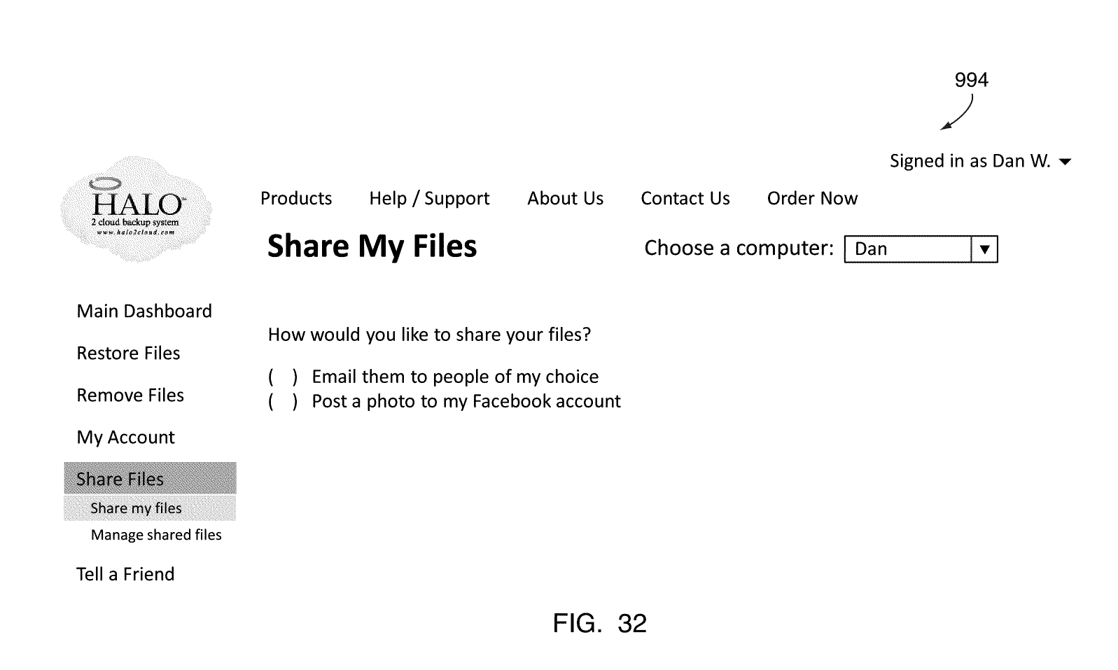

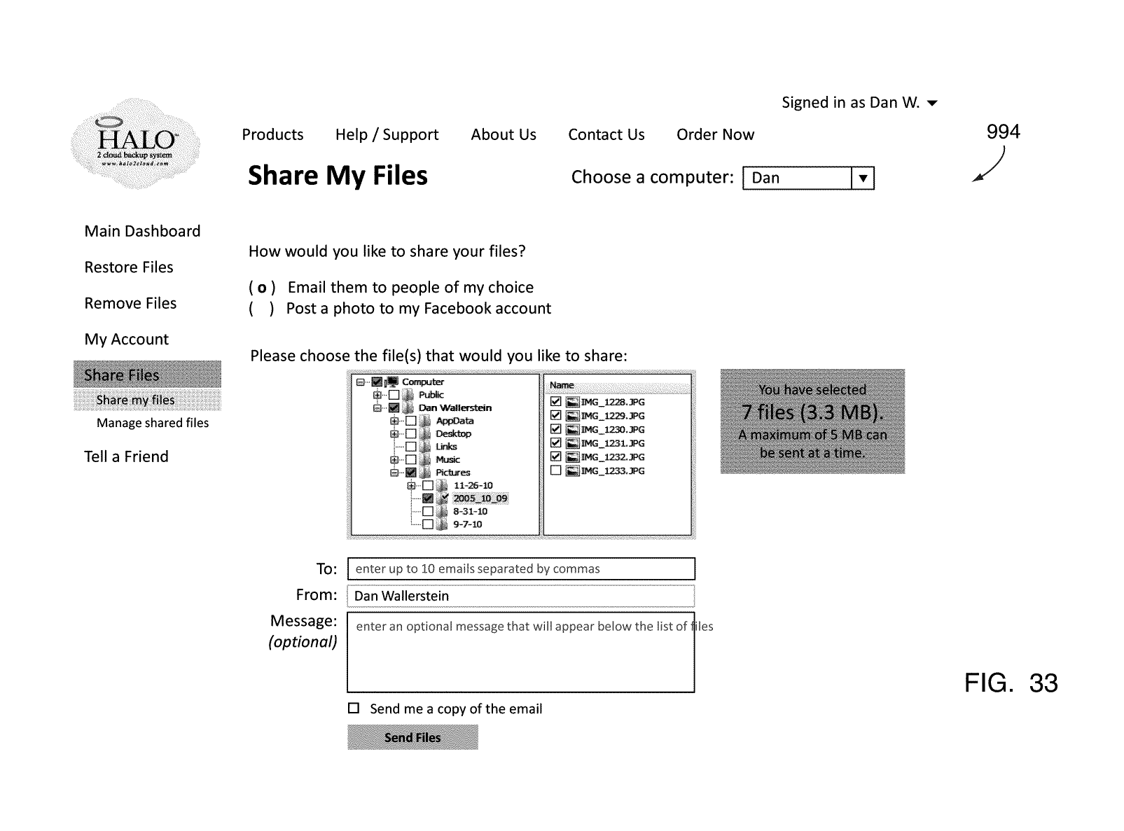

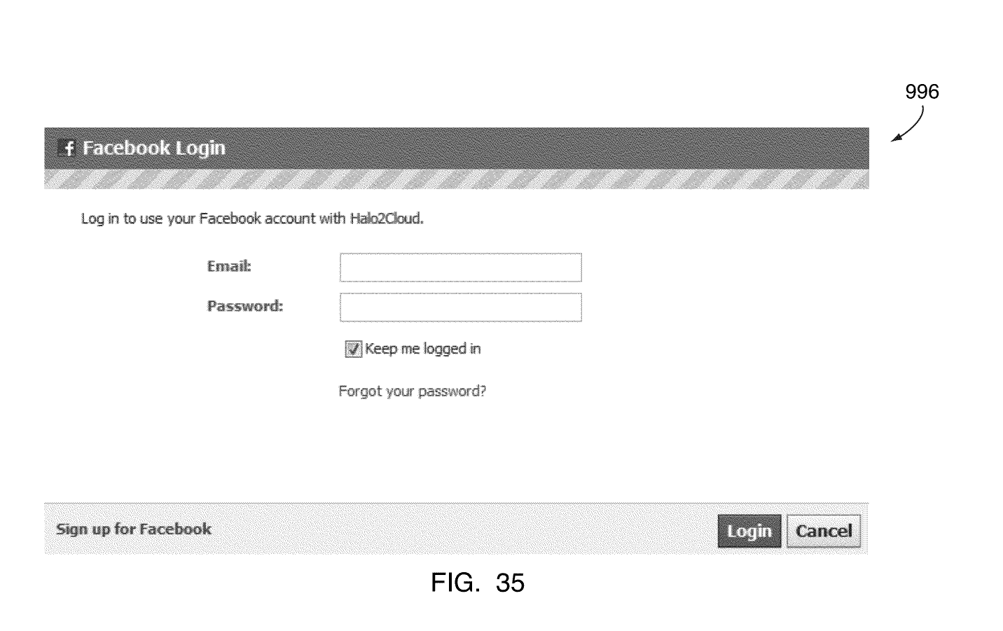

FIGS. 32-34 and 36 show an exemplary web browser interface 994 for sharing files with friends via email or FACEBOOK®. As shown in FIG. 33, web browser interface 994 allows a user to select which files to share and to indicate to whom the files should be emailed. As shown in FIG. 35, web browser interface 996 allows a user to log into his FACEBOOK®-account so that files can be share via FACEBOOK®. As shown in FIG. 33, web browser interface 994 allows a user to select which files to share via FACEBOOK®.

The foregoing description of embodiments of the present invention has been presented for the purpose of illustration and description. It is not intended to be exhaustive or to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular use contemplated.

What is claimed is:

1. A web portal configured to serve a web interface, said web interface comprising:
a first interface for viewing, downloading, restoring, or sharing selected user files in an online backup system;
a second interface for requesting physical delivery of selected user files in the online backup system; and
a third interface for accessing and managing user account information.

2. A web portal as claimed in claim 1, further comprising a directory interface for selecting files in the online backup system.

3. A web portal as claimed in claim 1, wherein the first interface includes an option for downloading a ZIP file of the selected user files.

4. A web portal as claimed in claim 1, further comprising a fourth interface for sharing information about the online backup system.

5. A web portal as claimed in claim 4, wherein the fourth interface includes an option for sharing files from the online backup system.
